(19) United States
(12) Patent Application Publication
(10) Pub. No.: US 2026/0048451 A1
(43) Pub. Date: Feb. 19, 2026

(54) AIR-GUIDING DEVICE FOR SPATTER REDUCTION, SPATTER DEFLECTION AND IMPROVEMENT OF A WELD SEAM QUALITY IN LASER BEAM WELDING, AND WELDING DEVICE

(71) Applicant: Adient US LLC, Plymouth, MI (US)

(72) Inventors: Arvid KRAUS, Imsbach (DE); Patrick Thomas DUTT, Völkersweiler (DE); Holger WEINGART, Niederkirchen-Wörsbach (DE); Johannes KRAUS, Landstuhl (DE)

(21) Appl. No.: 19/101,611

(22) PCT Filed: Aug. 1, 2023
(86) PCT No.: PCT/IB2023/057789

§ 371 Date: Feb. 6, 2025

(30) Foreign Application Priority Data
Aug. 8, 2022 (DE) 10 2022 208 240.0

(51) Int. Cl. B23K 26/14

(52) U.S. Cl. CPC B23K 26/1464

(57) ABSTRACT

An air-guiding device for influencing weld spatters during a machining of a workpiece may have at least one annular nozzle for generating an airflow directed to a weld point. The nozzle may have having at least one air inlet and at least one air outlet. The air inlet being arranged on an outer peripheral surface of the nozzle and opening out substantially tangentially into an air duct of the nozzle. A welding device having the air-guiding device is also provided.

The invention relates to an air-guiding apparatus for spatter reduction, spatter deflection and improvement of a weld seam quality by process stabilization, for example for influencing weld spatter and a vapor plume, and also process light, during processing of a workpiece. The invention further relates to a welding apparatus for processing a workpiece having at least one set of welding optics and an air-guiding apparatus, especially an optically fixed air-guiding apparatus.

### PRIOR ART

Laser welding systems have a laser beam source. A welding head is secured on a robot arm or other manipulator and has a set of welding optics that focus the laser beam on the workpiece. In the welding of coated or uncoated workpieces composed of weldable materials, the high energy density of the laser beam and the highly active melt bath often result in formation of weld spatter, meaning that molten particles are thrown out. In addition, incineration residues or coatings of the workpiece lead to formation of smoke or flue gas. These substances can easily damage or soil the welding optics. The welding optics are therefore usually protected by a protective glass. However, this protective glass must also be of high optical quality and is therefore comparatively costly. This is particularly true of scanning welding apparatuses and/or welding optics, where the laser beam is deflected by means of a mirror system and the protective glass must accordingly have a relatively high diameter.

A laser welding apparatus is known, for example, from DE 20 2015 102 740 U1, having a set of welding optics for beamforming of a laser beam directed onto a workpiece and having a spatter guard device in the form of a nozzle for generation of an air flow in a space between the welding optics and the workpiece.

### OBJECT

It is an object of the invention to improve an air-guiding apparatus of the type specified at the outset, especially by constant generation or by constant formation of an air flow that can be directed or is directed toward a weld site, which serves for control and reduction of an extent of vapor plumes and process light and for optimization of a weld seam quality by process stabilization, and for reduction and direction of weld spatter and weld smoke during a welding operation. Integration of air flow boosters enables simple retrofittability and energy-efficient operation. It is a further object of the invention to provide a corresponding welding apparatus, especially laser welding apparatus, comprising the aforementioned air-guiding apparatus, wherein the air-guiding apparatus is especially in an optically fixed arrangement and acts with a diabolo-shaped free-form jet, especially a diabolo-shaped air flow, without connection to the workpiece.

### ACHIEVEMENT OF OBJECT

The object is achieved in accordance with the invention by an air-guiding apparatus for influencing weld spatter during processing of a workpiece, comprising at least one annular nozzle for generating an air flow directed toward a weld site, wherein the nozzle has at least one air inlet and at least one air outlet, where the air inlet is disposed on an outer circumferential face of the nozzle and opens essentially tangentially into an air duct of the nozzle.

The air inlet, especially an inlet duct or inlet tube, opens essentially tangentially into the air duct of the nozzle. The air duct is of annular shape, for example. What is meant in particular by the wording that the air inlet opens essentially tangentially into the air duct of the nozzle is that an essentially linear air inlet opens into an annular air duct such that there is a moment of transition at which the linear-tangential air inlet flow becomes a circular air flow in the air duct.

Because the at least one air inlet is disposed at the outer circumferential face of the nozzle and opens tangentially into the air duct of the nozzle, it is possible to influence weld spatter, especially spreading weld spatter, to an improved degree.

The tangential arrangement of the air inlet and the fact that the air inlet opens tangentially into the air duct of the nozzle result in shortening of an air supply pathway and/or air flow generation pathway. This enables an air inlet with less deflection of air.

An air flow generated by means of the air-guiding apparatus of the invention, especially by means of the nozzle of the invention, leads to a reduction and/or deflection of weld spatter and/or vapor plumes. Such an air flow, especially a diabolo-shaped air flow, containing rotated components in the form of what is called a vortex, can substantially stabilize a welding process and achieve flat, compact process light.

In addition, a beam pathway is kept clear of weld spatter and weld smoke, which improves the service life of the optics.

The at least one air inlet, for example having an inlet opening and an inlet duct or inlet tube, may be aligned such that the inlet duct or inlet tube extends tangentially relative to the outer circumferential face of the annular nozzle and opens tangentially into the air duct, especially air space or cavity. Air supply into the air duct is thus tangential.

The tangential arrangement of the air inlet allows improved monitoring and controlling of the air flow directed toward the weld site. In addition, the tangential arrangement of the air inlet enables formation of the air flow with a desired flow rate and/or a desired air pressure. A diabolo-shaped air flow beneath the nozzle, especially what is called a vortex, can be generated in a simple and rapid manner.

The annular nozzle may be secured on a set of welding optics, for example a set of laser welding optics. The annular nozzle, in the case of scanner optics and/or optics having standard lens systems, may be employed with a fixed central welding jet, for example. The specific air flow that is generated by a gassing unit, for example, leads to optimized process robustness and controlled formation of vapor plumes and/or controlled spattering in any welding processes with any seam geometries.

The function of the air-guiding apparatus can be described as follows: The annular nozzle generates a rotationally symmetric air flow, especially air vortex, in the region of a jet axis. The at least one air inlet that opens tangentially into the air duct at the periphery of the annular nozzle can result in generation or formation of a tangential high-speed air flow. This air flow may be generated by at least one so-called air flow booster, also called air flow booster element later on.

The air rotating in the nozzle leaves the air duct, also called chamber, with high speed along the air outlet. By virtue of the resultant pressure conditions, additional ambient air flows from a region above and/or below the nozzle across a diameter of the annular nozzle, also called annular chamber, annular nozzle or nozzle ring, down to the plane of the weld.

Advantageous configurations, which may be used individually or in combination with one another, are the subject matter of the dependent claims.

The annular nozzle may be divided into segments. For example, the nozzle may comprise two, three or more air inlets.

In the case of multiple air inlets, the nozzle may be divided into a corresponding number of segments. In the case of two segments, these are each in semicircular form. Each semicircular segment of the nozzle may be assigned an air inlet. The two air inlets may be arranged on two mutually opposite outer circumferential faces of each segment. The air inlets may be in a mutually spaced-apart or offset arrangement within an angle range of 180°.

In the case of three air inlets, the nozzle may be divided into three segments. In particular, the nozzle may be divided into three identical segments, especially of equal size. Each segment of the nozzle here may be assigned an air inlet. The three air inlets may be in a rotationally symmetric distribution on the outer circumference. The air inlets may each be in a mutually spaced-apart or offset arrangement within an angle range of 120°.

The annular nozzle may be divided into four segments and have four air inlets. Each segment here may be assigned an air inlet. The four segments may be of equal size. The four air inlets may each be in a mutually spaced-apart arrangement at an equal distance and/or at an equal angle. The air inlets may be in a rotationally symmetric distribution over the outer circumferential face of the annular nozzle. The air inlets may each be in a mutually spaced-apart or offset arrangement within an angle range of 90°.

The function of the air-guiding apparatus can be described as follows: The annular nozzle generates a rotationally symmetric air flow, especially air vortex, in the region of the jet axis. This is accomplished by means of the segmented nozzle in annular duct form, especially by virtue of its air duct or its air chamber, with one air inlet per segment, where the air inlets enable introduction of a tangential high-speed air flow into the air duct or air chamber at the circumference of the nozzle, followed by discharge from the air outlet. This air flow may be generated by what are called air flow boosters that are operated with compressed air, or by means of a ventilation system having appropriate properties.

By means of the annular nozzle, also called ring nozzle, having a number or multitude of air inlets in a tangential arrangement, it is possible to generate a diabolo-shaped air flow, for example air vortex or vortex tube or vortex duct. For example, a rotationally symmetric air vortex may be generated beneath the nozzle. Such an air vortex may be achieved by the segmented nozzle in annular duct form with one air inlet per segment. The air rotating in the segments can leave the air duct, i.e. the nozzle, with high speed in the direction of the air outlet.

By means of the air outlet, for example in the form of an exit gap, the rotating air can be specifically concentrated by the inner circumferential face obliquely downward and slightly radially inward in the direction of the weld site.

The air outlet may take the form of a gap running around the inner circumferential face of the nozzle. The air outlet may take the form of an annular opening or an annular gap. The air outlet may take the form of an air exit opening or air exit gap. The air outlet may be formed in that two nozzle walls are in a mutually spaced-apart arrangement.

The air outlet may be aligned at a defined angle relative to a vertical axis running through the nozzle. The air outlet may be aligned at a defined angle from a plane defined by the inner circumferential face. The air outlet may be directed radially inward toward the weld site and at an angle of about 30° to 50°, especially 45°. The annular air outlet, for example, is directed at an angle of about 45° downward in the direction of the workpiece.

The air inlet may have an attachment interface by means of which the air inlet can be coupled or is coupled to an air flow booster element. The attachment interface can also be used to couple the air inlet to a conventional ventilation unit, a fan and/or a compressed air supply unit. The attachment interface may be an assembly interface and have a number of connecting elements, such as openings, for example screw openings, and/or screws or bolts. The air inlet may be releasably or non-releasably connected to the air flow booster element or to the ventilation unit. The air inlet may be force-fittingly, form-fittingly and/or cohesively bonded to the air flow booster element or to the ventilation unit.

The air flow booster element may be a conventional metal product. The air flow booster element may make use of what is called a Coanda effect in order to increase a volume flow rate which is forced through the annular nozzle.

In all the embodiments described, at least one of the air inlets or all air inlets can be provided with an air flow booster element.

The annular nozzle with air inlet and air outlet may be produced by 3D printing methods or injection molding methods. The annular nozzle may be manufactured from plastic, for example from a thermally stable plastic, for example PLA.

In the case of welding optics that are dynamically positioned with the aid of what are called handling systems, for example robots, a relatively lightweight material may be advantageous. If the air-guiding apparatus is fixedly mounted, for example, other materials may also be an option.

The annular nozzle may comprise at least one securing element for securing of the nozzle to a set of welding optics, welding cell and/or welding apparatus. The securing element may take the form of a securing opening, for example a passage opening, or a securing bolt or securing screw or securing site, such as a weld point or solder point. The securing element may be an interface for an assembly apparatus.

The annular nozzle may comprise two, three, four or more securing elements. Each segment of the nozzle may be assigned a securing element. The securing element(s) may be arranged on the outer circumferential face of the nozzle. Alternatively or additionally, the securing element(s) may be formed on a top side and/or bottom side and/or inner circumferential face.

In the case of two securing elements, these may be disposed on two mutually opposite outer circumferential faces of the nozzle. The securing elements may be in a mutually spaced-apart or offset arrangement within an angle range of 180°. For example, one securing element may be disposed between every two air inlets. The securing element and air inlet may be mutually spaced apart or offset within an angle range of 90°. The securing elements may be disposed in the middle between two air inlets.

In the case of three securing elements, these may be in a rotationally symmetric distribution on the outer circumference of the nozzle. The securing elements may each be in a mutually spaced-apart or offset arrangement within an angle range of 120°. The securing element and air inlet may be mutually spaced apart or offset within an angle range of 60°. The securing elements may be disposed in the middle between two air inlets.

In the case four securing elements, these may each be in a mutually spaced-apart arrangement at an equal distance and/or at an equal angle. The securing elements may be in a rotationally symmetric distribution over the outer circumferential face of the annular nozzle. The securing elements may each be in a mutually spaced-apart or offset arrangement within an angle range of 90°. A securing element may be disposed in each case between an end of a first air inlet and a start of a second air inlet. An end of an air inlet may be an opening site or else a transition site in which the air inlet opens tangentially into the air duct. The securing elements may be disposed in the middle between two air inlets.

The securing element(s) may be areas embossed into the body of the nozzle. The securing element(s) may take the form of passage openings, passage bores or passage holes that run coaxially to the passage of the annular nozzle. The nozzle may have one or more securing elements that may be in one-piece form together with a nozzle body. The securing element(s) may take the form of loops or lugs mounted on or embossed into the nozzle.

The securing element(s) can be used for releasable connection of corresponding securing elements provided on the welding apparatus, welding cell and/or welding optics.

The object is additionally achieved in accordance with the invention by a welding apparatus for processing a workpiece having at least one set of welding optics for forming a welding jet directed onto the workpiece and an air-guiding apparatus, connected to the set of welding optics, according to the preceding description for production of an air flow directed onto a weld site.

The welding apparatus may be a laser welding apparatus having a set of welding optics for forming of a laser beam. The welding apparatus may comprise a retaining apparatus for securing the air-guiding apparatus for generation of an air flow directed onto a weld site.

The air-guiding apparatus may be disposed in a space between the welding optics and the workpiece.

The air-guiding apparatus may be arranged relative to the welding optics such that the welding jet from the welding optics runs through a nozzle hole in the annular nozzle. The annular nozzle may surround the welding jet in an annular manner. The air outlet may be set up such that the air flow is aligned radially inward and obliquely in the direction of the weld site. The annular nozzle may be secured on the welding optics by means of the at least one securing element, which may be disposed on an outer circumferential face of the nozzle, in such a way as not to affect a beam path of the welding jet.

In summary, and in other words, the invention provides an air-guiding apparatus in the form of an air flow generator, where the air flow that develops between the annular or toroidal nozzle and the weld point leads to constant formation of a vapor plume with reduced optical density during welding. In addition, the number and intensity of weld spatters is reduced. Furthermore, deflection of the spatters in the radial direction outward is achievable. As a result of these effects, the stability of a welding process, especially laser welding process, is very substantially increased. Moreover, better protection of the sensitive optical elements from soiling or even damage can be achieved.

The air-guiding apparatus simultaneously generates a downward vortex. The air-guiding apparatus may be constructed and manufactured as a 3D print from a thermally stable plastic.

The at least one air inlet, for example having an inlet opening and an inlet duct or inlet tube, may be aligned such that the inlet duct or inlet tube extends tangentially relative to the outer circumferential face of the annular nozzle and opens tangentially into the air duct, especially air space or cavity. Air supply into the air duct is thus preferably essentially tangential.

The tangential arrangement of the air inlet allows improved monitoring and controlling of the air flow directed toward the weld site. In addition, the tangential arrangement of the air inlet enables accelerated formation of the air flow with a desired flow rate and/or a desired air pressure. A diabolo-shaped air flow beneath the nozzle, especially what is called a vortex, can be generated in a simple and rapid manner.

### FIGURES AND EMBODIMENTS OF THE INVENTION

The invention is elucidated in detail hereinafter with reference to advantageous working examples shown in the figures. However, the invention is not limited to these working examples. The figures show:

FIG. 1: a perspective view of an air-guiding apparatus of the invention according to a first working example, having an annular nozzle for generating an air flow directed toward a weld site,

FIG. 2: a top view of the air-guiding apparatus of the invention according to the first working example,

FIG. 3: a section along the I-I line in FIG. 1,

FIG. 4: a side view of the air-guiding apparatus of the invention according to the first working example,

FIG. 5: a top view of an air-guiding apparatus of the invention according to a second working example, having an annular nozzle for generating an air flow directed toward a weld site and air flow booster elements,

FIG. 6: a perspective view of an air flow booster element, and

FIG. 7: a perspective view of a welding apparatus of the invention, especially laser welding apparatus, having a set of welding optics and an air-guiding apparatus connected thereto.

Mutually corresponding parts are given the same reference numerals in all figures.

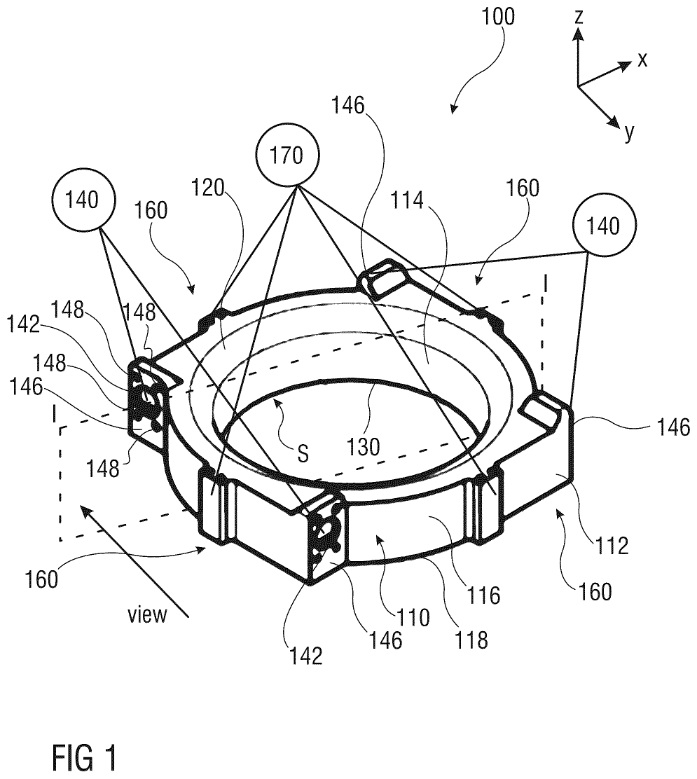

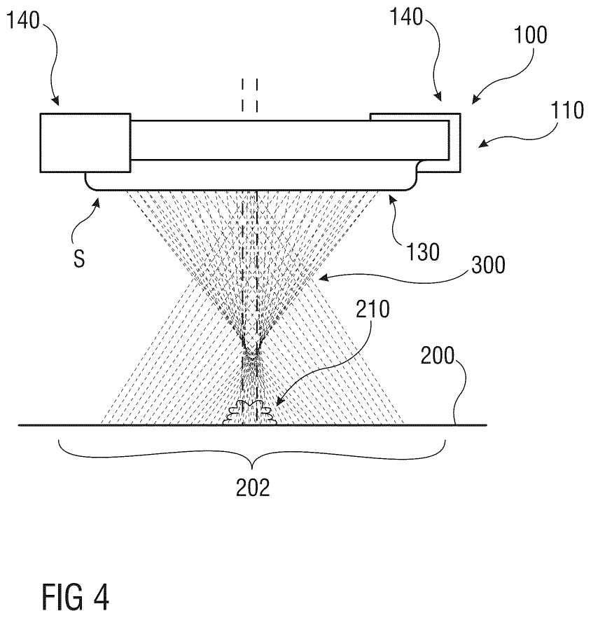

FIG. 1 shows an air-guiding apparatus 100 according to a first working example for influencing welding spatter 210 and/or vapor plumes and/or process light and/or weld smoke during processing, especially a welding operation, of a workpiece 200, as shown in FIGS. 4 and 9.

FIG. 1 shows, in schematic form, a coordinate system for illustration of three mutually perpendicular spatial directions: a longitudinal direction x, a cross direction y running at right angles to longitudinal direction x, and a vertical direction z running at right angles to longitudinal direction x and at right angles to cross direction y.

The air-guiding apparatus 100 comprises an annular nozzle 110 for generating an air flow 300 directed toward a weld site 202, as shown in FIG. 4.

The nozzle 110 comprises an annular main body 112 having an inner wall 114, an outer wall 116, a bottom side 118 and a top side 120. The top side 120 connects the inner wall 114 and the outer wall 116. The outer wall 116 is connected to the bottom side 118. A gap S is formed between the bottom side 118 and the inner wall 114. The gap S forms an air outlet 130 of the nozzle 110. The main body 112 may be in one-piece form. The air outlet 130 is an annular gap S formed between the inner wall 114 and the bottom side 118 of the nozzle 110. The air outlet 130 is formed by the gap S formed between the inner wall 114 and the bottom side 118. The air outlet 130 runs along an inner circumferential face of the nozzle 110.

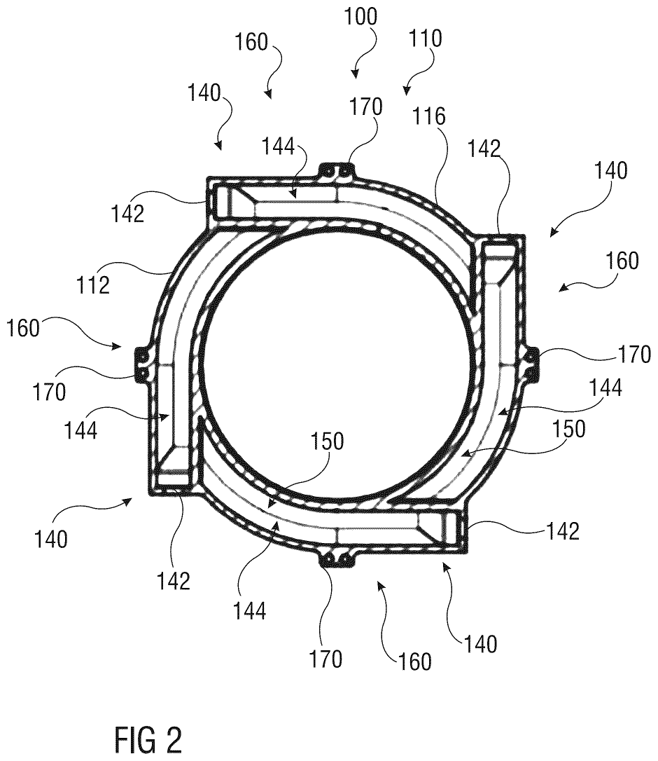

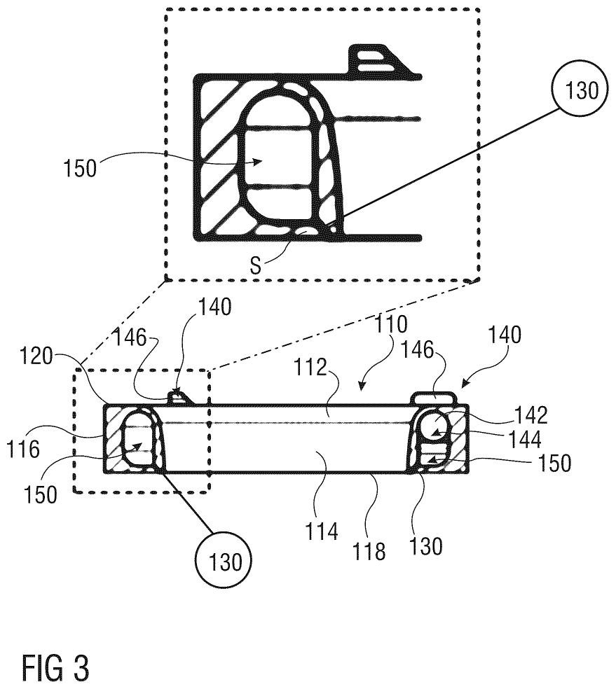

In addition, the nozzle 110 has four air inlets 140 distributed in a rotationally symmetric manner on the outer circumference. The air inlets 140 are is disposed on an outer circumferential face of the main body 112 and opens tangentially into an air duct 150, as shown in FIGS. 2 and 3, of the nozzle 110. The air duct 150 runs in an annular manner through the main body 112. The air duct 150 is formed by the inner wall 114, the outer wall 116, the bottom side 118 and the top side 120.

The air inlets 140 each open tangentially into the air duct 150. The air inlets 140 project tangentially from the circumference, especially from the outer wall 116, of the nozzle 110. The air inlets 140 each comprise an inlet opening 142 and an inlet duct 144, as can be seen in FIGS. 2 and 3, where the inlet duct 144 extends tangentially relative to the outer circumferential face of the annular nozzle 110 defined by the outer wall 114 and opens tangentially into the air duct 150, especially air space or cavity. Air supply into the air duct 150 is thus tangential.

The respective inlet opening 142 and/or the respective inlet duct 144 may have, for example, a smaller cross-sectional area than the air duct 150. A shape of the air duct 150 may vary. For example, the air duct 150 is round or oval-shaped. The air duct 150 may have a greater cross-sectional area than that of the respective inlet opening 142 and/or of the respective inlet duct 144.

In the working example shown, the respective air inlet 140 is in essentially tubular form or may have a different shape.

The air inlets 140 each have an attachment interface 146 by means of which the respective air inlet 140 can be coupled or is coupled to a ventilation unit 400 shown in FIG. 9, for example a fan and/or a compressed air supply unit. In the working example shown, the respective attachment interface 146 extends in vertical direction z. Optionally, the respective attachment interface 146 may also extend in cross direction y and/or longitudinal direction x. The attachment interfaces 146 take the form, for example, of an attachment plate. The respective attachment interface 146 comprises, for example, a number of attachment openings 148, for example passage bores or passage holes, for example for screws, bolts and/or pins. In the working example shown, each attachment interface 146 comprises four attachment openings 148 distributed around the respective air inlet 140, especially around the respective inlet opening 142.

The tangential arrangement of the air inlets 140 allows the air flow 300 to be more effectively monitored, aligned and controlled. Flow rates of the air flow 300 may be adjusted individually by the ventilation unit 400. In addition, the tangential arrangement of the air inlets 140 enables formation of the air flow 300 with a desired flow rate and/or a desired air pressure. The tangential arrangement of the air inlets 140 shortens a supply pathway and hence formation distance of the air flow 300. A diabolo-shaped air flow 300 beneath the nozzle 110, especially what is called a vortex, can be generated in a simple, rapid and controlled manner.

The function of the air-guiding apparatus 100 can be described as follows: The annular nozzle 110 generates a rotationally symmetric air flow 300, especially air vortex, in the region of a jet axis running in longitudinal direction x, where air is fed into the air duct 150 of the nozzle 110 simultaneously or with a time delay via the air inlets 140. This is done by means of the segmented nozzle 110 in annular duct form with one air inlet 140 per segment 160, where the air inlets 140 result in introduction of a tangential high-speed air flow into the air duct 150 at the circumference of the nozzle 140, followed by discharge from the air outlet 130. This air flow 300 may be generated by what are called air flow boosters that are operated with compressed air, and/or by means of a ventilation system having appropriate properties.

The air rotating in the nozzle 110 leaves the air duct 150 with high speed along the air outlet 130. By virtue of the resultant pressure conditions, additional ambient air flows from a region above and/or below the nozzle 110 across a diameter of the annular nozzle 110, also called annular chamber, annular nozzle or nozzle ring, down to the plane of the weld.

The annular nozzle 110 is divided into four segments 160. Each segment 160 is assigned an air inlet 140. The four segments 160 are of equal size. The four air inlets 140 are each in a mutually spaced-apart arrangement at an equal distance and/or at an equal angle. The air inlets 140 are in a rotationally symmetric distribution over the outer circumferential face of the annular nozzle 110. The air inlets 140 are each in a mutually spaced-apart or offset arrangement within an angle range of 90°.

The annular nozzle 110 comprises four securing elements 170, distributed over the outer wall 116 and hence over the outer circumferential face, for securing the nozzle 110 to a welding apparatus 500. The respective securing element 170 may comprise at least one passage opening running in longitudinal direction x. The securing elements 170 each form an interface for an assembly apparatus.

The securing elements 170 extend in vertical direction z over a total height of the nozzle 110, especially along the outer wall 116. The securing elements 170 take the form, for example, of elevations that project from the outer wall 116.

The securing elements 170 are each in a mutually spaced-apart arrangement at an equal distance and/or at an equal angle. The securing elements 170 are in a rotationally symmetric distribution over the outer circumferential face of the annular nozzle 110. The securing elements 170 are each in a mutually spaced-apart or offset arrangement within an angle range of 90°. A securing element 170 is disposed in the middle in each case between two air inlets 140.

The securing elements 170 may be surfaces, pockets and/or loops embossed into the main body 112 of the nozzle 110. The securing elements 170 can be used for releasable connection of corresponding securing elements provided on the welding apparatus 500 and/or on a set of welding optics 502, such as screws.

FIG. 2 shows a top view of the air-guiding apparatus 100 of the invention according to the first working example.

The main body 112 of the nozzle 110 is divided into four segments 160. Each segment 160 is assigned an air inlet 140 and a securing element 170. The air inlets 140 each open tangentially into the air duct 150 of the nozzle 110. The securing elements 170 each have two passage openings.

By virtue of this manner of securing the nozzle 110 to a welding apparatus 500 and/or to a set of welding optics 502 and/or to a ventilation unit 400, the functioning of the nozzle 110 can proceed in an unhindered and unrestricted manner.

FIG. 3 shows a section along the I-I line in FIG. 1.

The air outlet 130 is aligned at a defined angle relative to a vertical axis running through the nozzle 110. In the working example shown, the outer wall 116 and the inner wall 114 run essentially parallel to the vertical direction z and/or the vertical axis.

The air outlet 130 is accordingly aligned inward at a defined angle relative to the outer wall 116 and/or inner wall 114. The air outlet 130 is aligned at a defined angle from a plane defined by the inner circumferential face.

The air outlet 130 is directed radially inward and at an angle of about 30° to 50°, especially 45°, relative to the vertical axis. The annular air outlet 130 may be directed at this angle of about 45°, for example, in the direction of the workpiece 200 to be processed, or directed in the direction of a point above the workpiece 200 for formation of a diabolo waist.

The respective air inlet 140, especially inlet duct 144, may have a cross-sectional area smaller than a cross-sectional area of the air duct 150. The cross section of the respective air inlet 140, especially the inlet duct 144, may optionally be greater than the cross section of the air duct 150. In a further variant, the respective air inlet 140, especially inlet duct 144, may have a cross section equal to that of the air duct 150.

The air inlet 140, especially inlet duct 144, may open into the air duct 150 above a direction of extension or direction of expansion thereof. Optionally or alternatively additionally, the air inlet 140, especially inlet duct 144, may open into the air duct 150 laterally with respect to the direction of extension or direction of expansion thereof.

FIG. 4 shows a side view of the air-guiding apparatus 100 of the invention according to the first working example.

By means of the annular nozzle 110, also called ring nozzle, having a tangential arrangement of air inlets 140, it is possible to generate a diabolo-shaped air flow 300, for example air vortex or vortex tube or vortex duct. What is meant in particular by a diabolo-shaped air flow 300 is an air flow which is generated in double-cone form or in the form of two opposite and mutually overlapping, especially rotationally symmetric, cones or of two opposite and mutually overlapping, especially rotationally symmetric, hemispheres. The mutually opposite forms, especially hemispheres, may, for example, have identically convex outer surfaces.

For example, a rotationally symmetric air vortex may be generated beneath the nozzle 110. Such an air vortex may be achieved by the segmented nozzle 110 in annular duct form with one air inlet 140 per segment 160 (as shown in FIGS. 1 and 2). The air rotating in the segments 160, especially toroidal segments 160, can leave the air duct 150, i.e. the nozzle 110, with high velocity via the air outlet 130. In a working example not shown in detail, the nozzle 110 may be in essentially toroidal form.

By means of the air outlet 130, the rotating air from the inner circumferential face can be specifically concentrated radially in the direction of the weld site 202.

An air flow 300 generated by means of the air-guiding apparatus 100 of the invention, especially by means of the nozzle 110 of the invention, leads to a reduction and/or deflection of weld spatter 210. Such an air flow 300 can substantially stabilize a welding process and achieve flat, compact process light and a reduced vapor plume. In addition, a beam pathway is kept clear of weld spatter 210 and weld smoke.

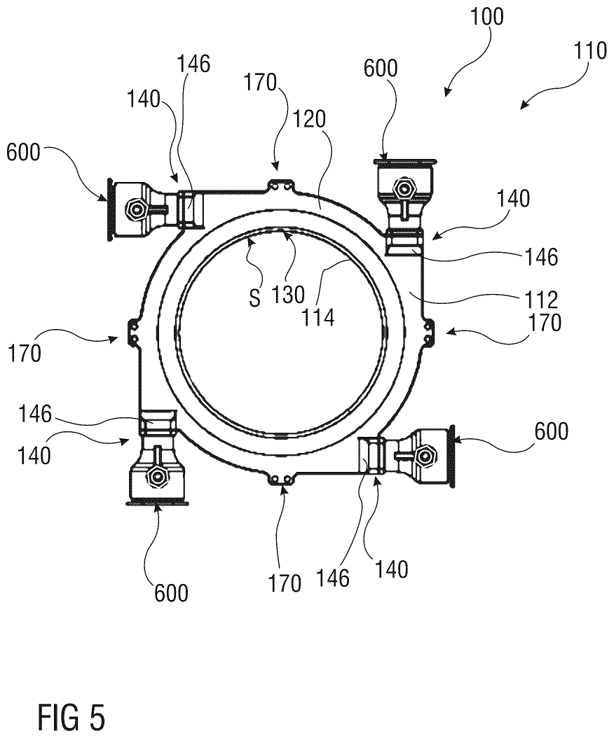

FIG. 5 shows a top view of an air-guiding apparatus 100 of the invention according to a second working example, having an annular nozzle 110 for generation of an air flow 300 directed toward a weld site 202 and air flow booster elements 600.

The nozzle 110 comprises an annular main body 112 having an inner wall 114, an outer wall 116, a bottom side 118 and a top side 120. The top side 120 connects the inner wall 114 and the outer wall 116. The outer wall 116 is connected to the bottom side 118. A gap S is formed between the bottom side 118 and the inner wall 114. The gap S forms an air outlet 130 of the nozzle 110. The main body 112 may be in one-piece form. The air outlet 130 is an annular gap S formed between the inner wall 114 and the bottom side 118 of the nozzle 110. The air outlet 130 is formed by the gap S formed between the inner wall 114 and the bottom side 118. The air outlet 130 runs along an inner circumferential face of the nozzle 110.

In addition, the nozzle 110 has four air inlets 140 distributed in a rotationally symmetric manner on the outer circumference. The air inlets 140 are disposed on an outer circumferential face of the main body 112 and open tangentially into an air duct 150 of the nozzle 110, as shown in FIGS. 2 and 3. The air duct 150 runs in an annular manner through the main body 112. The air duct 150 is formed by the inner wall 114, the outer wall 116, the bottom side 118 and the top side 120.

The air inlets 140 each open tangentially into the air duct 150. The air inlets 140 project tangentially from the circumference, especially from the outer wall 116, of the nozzle 110. The air inlets 140 each comprise an inlet opening 142 and an inlet duct 144, as can be seen in FIGS. 2 and 3, where the inlet duct 144 extends tangentially relative to the outer circumferential face of the annular nozzle 110 defined by the outer wall 114 and opens tangentially into the air duct 150, especially air space or cavity. Air supply into the air duct 150 is thus tangential.

In a further working example, the air inlets 140 may each open into the air duct 150 of the nozzle 110 at an azimuthal angle. For example, such an angle may be 20° to 50°, especially 45°.

In the working example shown, the respective air inlet 140 is in essentially tubular form. Optionally, the respective air inlet 140 may have an oval cross section or one of different shape.

The air inlets 140 each have an attachment interface 146 by means of which the respective air inlet 140 can be coupled to a ventilation unit 400 shown in FIG. 9, for example a fan and/or a compressed air supply unit. In the working example shown, the respective air inlet 140 has been provided with an air flow booster element 600.

The respective air inlet 140 may be releasably or non-releasably connected to the air flow booster element 600.

The air flow booster element 600 may be a conventional metal product. The air flow booster element 600 may make use of what is called a Coanda effect in order to increase a volume flow rate which is forced through the annular nozzle 110.

The air flow booster elements 600, in the assembled state, are connected between the nozzle 110 and a ventilation unit 400. The air flow booster elements 600 are operable with compressed air and/or by means of a ventilation unit 400 with appropriate properties.

The air flow booster elements 600 are in a rotationally symmetric distribution over the outer circumferential face of the nozzle 110. The air flow booster elements 600 project tangentially from the outer circumferential face of the nozzle 110.

The attachment interfaces 146 take the form, for example, of an attachment plate. The respective attachment interface 146 comprises, for example, a number of attachment openings 148, for example passage bores or passage holes, for example for screws, bolts and/or pins. In the working example shown, each attachment interface 146 comprises four attachment openings 148 distributed around the respective air inlet 140, especially around the respective inlet opening 142.

The tangential arrangement of the air inlets 140 allows the air flow 300 to be more effectively monitored, aligned and controlled. Flow rates of the air flow 300 may be adjusted individually by the ventilation unit 400. In addition, the tangential arrangement of the air inlets 140 enables accelerated formation of the air flow 300 with a desired flow rate and/or a desired air pressure. The tangential arrangement of the air inlets 140 shortens a supply pathway and hence formation distance of the air flow 300. A diabolo-shaped air flow 300, especially what is called a vortex or vortex tube, can be generated in a simple, rapid and controlled manner.

The function of the air-guiding apparatus 100 can be described as follows: The annular nozzle 110 generates a rotationally symmetric air flow 300, especially air vortex, in the region of a jet axis running in longitudinal direction x, where air is fed into the air duct 150 of the nozzle 110 simultaneously or with a time delay via the air inlets 140. This is done by means of the segmented nozzle 110 in annular duct form with one air inlet 140 per segment 160, where the air inlets 140 result in introduction of a tangential high-speed air flow into the air duct 150 at the circumference of the nozzle 140, followed by discharge from the air outlet 130. This air flow 300 may be generated by what are called air flow boosters that are operated with compressed air, and/or by means of a ventilation system having appropriate properties.

The air rotating in the nozzle 110 leaves the air duct 150 with high speed along the air outlet 130. By virtue of the resultant pressure conditions, additional ambient air flows from a region above and/or below the nozzle 110 across a diameter of the annular nozzle 110, also called annular chamber, annular nozzle or nozzle ring, down to the plane of the weld.

The annular nozzle 110 is divided into four segments 160. Each segment 160 is assigned an air inlet 140. The four segments 160 are of equal size. The four air inlets 140 are each in a mutually spaced-apart arrangement at an equal distance and/or at an equal angle. The air inlets 140 are in a rotationally symmetric distribution over the outer circumferential face of the annular nozzle 110. The air inlets 140 are each in a mutually spaced-apart or offset arrangement within an angle range of 90°.

The annular nozzle 110 comprises four securing elements 170, distributed over the outer wall 116 and hence over the outer circumferential face, for securing the nozzle 110 to a welding apparatus 500. The respective securing element 170 may comprise at least one passage opening running in longitudinal direction x. The securing elements 170 each form an interface for an assembly apparatus.

The securing elements 170 are each in a mutually spaced-apart arrangement at an equal distance and/or at an equal angle. The securing elements 170 are in a rotationally symmetric distribution over the outer circumferential face of the annular nozzle 110. The securing elements 170 are each in a mutually spaced-apart or offset arrangement within an angle range of 90°. A securing element 170 is disposed in the middle in each case between two air inlets 140.

The securing elements 170 may be surfaces, pockets and/or loops embossed into the main body 112 of the nozzle 110. The securing elements 170 can be used for releasable connection of corresponding securing elements provided on the welding apparatus 500 and/or on a set of welding optics 502, such as screws.

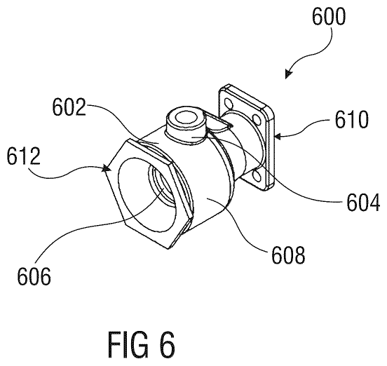

FIG. 6 shows a perspective view of an air flow booster element 600.

The air flow booster element 600 comprises a conical booster body 602. The booster body 602 comprises an entry opening 604 arranged essentially at right angles to an entry duct 606. The entry opening 604 and entry duct 606 are connected to one another for air supply.

The entry opening 604 projects from an outer circumferential face of the booster body 602. The entry duct 606, in the assembled state of the air flow booster element 600 and the nozzle 110, is coaxially and fluidically connectable or connected to the respective air inlet 140 of the nozzle 110.

At an end with greater diameter, the booster body 602 has a suction funnel 608 for sucking in ambient air when compressed air is supplied through the entry opening 604. At an end with smaller diameter, the booster body 602 has an exit opening 610.

The exit opening 610, in the assembled state of the air flow booster element 600 and the nozzle 110, is coaxially and fluidically connectable or connected to the respective air inlet 140 of the nozzle 110. In addition, the air flow booster element 600 may comprise a closure element 612 to control the gap in the booster body 602.

The closure element 612 may be an annular seal element. The closure element 612 is, for example, inserted into the booster body 602.

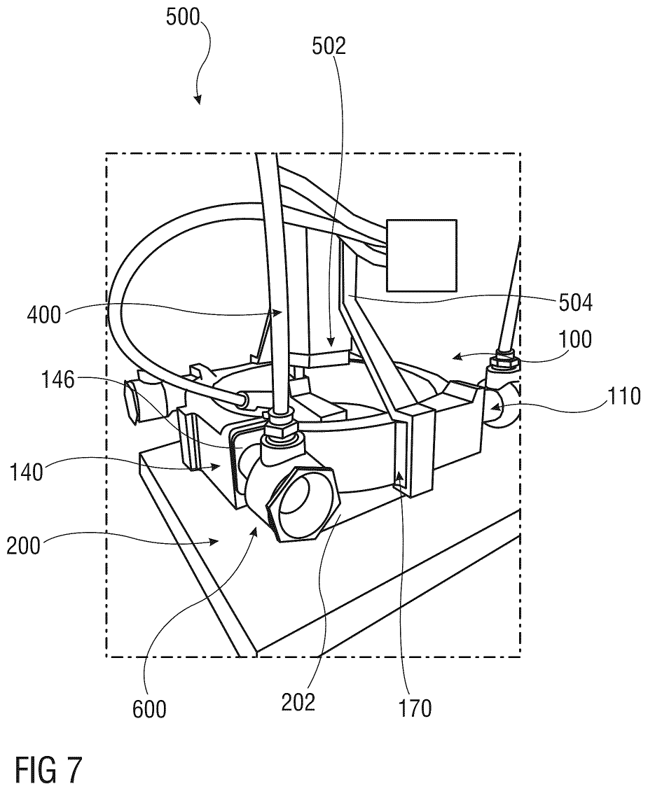

FIG. 7 shows a perspective view of a welding apparatus 500 of the invention, especially laser welding apparatus, having a set of welding optics 502 and an air-guiding apparatus 100 connected thereto.

The air-guiding apparatus 100 is disposed in a space between the welding optics 502 and the workpiece 200. In the working example shown, the air-guiding apparatus 100 is provided with air flow booster elements 600, by means of which the air-guiding apparatus 100 is connected to the ventilation unit 400.

The air-guiding apparatus 100 may be arranged relative to the welding optics 502 such that a welding jet from the welding optics 502 runs through a central nozzle hole in the annular nozzle 110. The annular nozzle 110 may surround the welding jet in an annular manner. The air outlet 130 may be set up such that the air flow 300 is aligned radially inward and obliquely in the direction of the weld site 202. The annular nozzle 110 may be secured on the welding optics 502 by means of the securing elements 170 disposed on the outer circumferential face of the nozzle 110 in such a way as not to affect the beam path of the welding jet. The nozzle 110 is connected to the welding optics 502, for example, via four retaining elements 504. The retaining elements 504 are secured, for example, by means of screws on the respective securing element 170 of the nozzle 110. The retaining elements 504 are, for example, supporting arms. The retaining elements 504 encircle the securing elements 170 at an upper end and a lower end in vertical direction z. For example, the upper end and the lower end each conclude flush with the top side 120 and the bottom side 118 of the nozzle 110, especially the main body 112 thereof.

In summary, and in other words, the invention provides an air-guiding apparatus 100 in the form of an air flow generator, where the air flow 300 that develops between the annular or toroidal nozzle 110 and the weld point 202 leads to constant formation of a vapor plume with reduced optical density during a welding operation. In addition, the number and intensity of weld spatters 210 is reduced. Furthermore, deflection of the weld spatters 210 in the radial direction outward is achievable. As a result of these effects, the stability of a welding process, especially laser welding process, is very substantially increased. Moreover, better protection of the sensitive welding optics 502 from soiling or even damage can be achieved.

The features which are disclosed in the above description, in the claims and in the figures may be of significance both individually and in combination for the implementation of the invention in its various embodiments, provided that they remain within the scope of protection of the claims.

List of reference numerals

| | |
|---|---|
| 100 | air-guiding apparatus |
| 110 | nozzle |
| 112 | main body |
| 114 | inner wall |
| 116 | outer wall |
| 118 | bottom side |
| 120 | top side |
| 130 | air outlet |
| 140 | air inlet |
| 142 | inlet opening |
| 144 | inlet duct |
| 146 | attachment interface |
| 148 | attachment opening |
| 150 | air duct |
| 160 | segment |
| 170 | securing element |
| 200 | workpiece |
| 202 | weld site |
| 210 | weld spatter |
| 300 | air flow |
| 400 | ventilation unit |
| 500 | welding apparatus |
| 502 | welding optics |
| 504 | retaining element |
| 600 | air flow booster element |
| 602 | booster body |
| 604 | entry opening |
| 606 | entry duct |
| 608 | suction funnel |
| 610 | exit opening |
| 612 | closure element |
| S | gap |
| x | longitudinal direction |
| y | cross direction |
| z | vertical direction |

1-10. (canceled)

11. An air-guiding apparatus for influencing weld spatter during processing of a workpiece, comprising at least one annular nozzle for generating an air flow directed toward a weld site,
characterized in that the nozzle has at least one air inlet and at least one air outlet, where the air inlet is disposed on an outer circumferential face of the nozzle and opens essentially tangentially into an air duct of the nozzle, where a diabolo-shaped air flow is generatable by means of the nozzle with at least one air inlet in tangential arrangement.

12. The air-guiding apparatus as claimed in claim 11, characterized in that the nozzle is divided into at least two segments, where each segment is assigned an air inlet.

13. The air-guiding apparatus as claimed in claim 11, characterized in that the nozzle is divided into four segments, where each segment is assigned an air inlet.

14. The air-guiding apparatus as claimed in claim 11, characterized in that the air inlets are in a rotationally symmetric distribution over the outer circumferential face of the nozzle.

15. The air-guiding apparatus as claimed in claim 11, characterized in that the air outlet is disposed on an inner circumferential face of the nozzle.

16. The air-guiding apparatus as claimed in claim 15, characterized in that the air outlet takes the form of a gap running around the inner circumferential face of the nozzle.

17. The air-guiding apparatus as claimed claim 11, characterized in that the air outlet is aligned at a defined angle from a plane defined by the inner circumferential face.

18. The air-guiding apparatus as claimed in claim 11, characterized in that the air inlet has an attachment interface by means of which the air inlet can be coupled or is coupled to an air flow booster element and/or a ventilation unit.

19. The air-guiding apparatus as claimed in claim 11, characterized in that the nozzle comprises at least one securing element for securing the nozzle to a welding apparatus.

20. A welding apparatus for processing a workpiece having at least one set of welding optics or forming a welding jet directed onto the workpiece and an air-guiding apparatus, connected to the set of welding optics, as claimed in claim 11 for production of an air flow directed onto a weld site, characterized in that the air-guiding apparatus is in an optically fixed arrangement.
